(19) United States
(12) Patent Application Publication
(10) Pub. No.: US 2004/0236932 A1
(43) Pub. Date: Nov. 25, 2004

(54) Apparatus and method for firmware upgrade in microprocessor-based processing units

(76) Inventors: Zhahong Zhang, Missouri City, TX (US); Mark Edward Utter, Indianapolis, IN (US); Mruthyunjaya Shastry, Stafford, TX (US); Gregory Robert Hewes, Missouri City, TX (US)

Correspondence Address: TEXAS INSTRUMENTS INCORPORATED, P O BOX 655474, M/S 3999, DALLAS, TX, 75265

(21) Appl. No.: 10/441,603

(22) Filed: May 20, 2003

(51) Int. Cl. G06F 15/177

(52) U.S. Cl. 713/1

(57) ABSTRACT

In a device having a central processing unit, a non-volatile includes a pre-boot program section including an upgrade section, a boot program section, and a functional program section. The pre-boot section includes a predetermined location. When an upgrade is requested, the upgrade program causes a preselected signal to be removed from predetermined location in the pre-boot program. When the upgrade process is complete, the upgrade program causes the preselected signal to be restored to the predetermined location. During execution of the pre-boot program section, when the preselected signal is not present in the predetermined location, then the pre-boot program causes the upgrade program to be executed. The pre-boot program is executed in response to a power on or a reset signal.

### 1. FIELD OF THE INVENTION

This invention relates generally to the self-contained processing units such as are used to decode compressed audio files and, more particularly, to the upgrading of the firmware in the self-contained processing unit.

### 2. BACKGROUND OF THE INVENTION

Referring to FIG. 1, a block diagram of a microprocessor-based processing device 10 that can be adapted to use advantageously the present invention is shown. A central processing 101 can receive data input signals and transmit data output signals. For example, the data input signals can be compressed audio files from a CD player or the internet and the data output signals can be the audio files, after expansion, for application to a speaker system. The central processing unit 101 also has POWER ON/RESET signals and USER signals applied thereto. When the device 10 is to be activated or reset, a POWER ON/RESET signal is applied to the central processing unit. The central processing unit 101, in response to the POWER ON/RESET signal retrieves signals stored in the boot section 1021 of non-volatile-memory unit 102. The signals in the boot section permit the central processing unit 101 to be initialized. After the initialization of the central processing unit 101, the central processing unit 101 is then able to respond to user signals to perform selected functions. Typically, in response to user signals, the contents of the one of the unspecified sections 1023-1029 must be transferred from the memory unit 102 to the central processing unit 101 in order to perform the requested (i.e., via the USER signals) functional activity.

In the foregoing device, it is necessary to have a technique for upgrading the contents of the functional memory sections 1023-1029. These upgrades are required to perform new functions as well as improve the performance of already installed functions. To accomplish this upgrade, the memory unit 102 has an upgrade section 1022. In response to user signals, the central processing unit 101 retrieves the signals stored in the upgrade section 1022. The central processing unit 101 then activates an external device, such as a CD player or the internet interface, and stores resulting data input signals in the designated functional sections 1023-1029 of the memory unit 102. In this manner, the contents of the functional sections 1023-1029 can be changed or can program material added.

This technique for upgrading the software/firmware of a device has proven very effective. The upgrade material can be provided to the user on CDs or can be provided over the internet. However, in the past, a problem has arisen. If the upgrade process fails for some reason, such as loss of power, the system will cease functioning. The system then has to be shipped to the manufacturer for reprogramming of the non-volatile memory.

A need has therefore been for apparatus and an associated method having the feature that a device with a central processing device can be upgraded. It would be further feature of the apparatus and associated method to upgrade a device with a central processing unit when the upgrade is interrupted. It would be a still further feature of the present invention to provide a location in the boot program of a device with a central processing unit, the location indicating the presence of a completed upgrade process.

### SUMMARY OF THE INVENTION

The aforementioned and other features are accomplished, according to the present invention by providing a in a non-volatile memory a pre-boot program that includes an upgrade program, a boot program, and functional programs. When an upgrade process is initiated, a signal or flag stored in a preselected location in the pre-boot section of the volatile memory unit is removed and the upgrade procedure implemented. When the upgrade procedure is complete, the signal is restored to the predetermined location in the pre-boot section of the non-volatile memory. During an initiation or reset procedure, the pre-boot program determines whether the signal (or upgrade flag) is been stored in the predetermined location. When the signal is present in the predetermined location, then the pre-boot program operates in the normal manner and initiates the boot program. When the preselected signal is not present, then the pre-boot program invokes the upgrade program and the upgrade program is re-executed. Upon completion of the upgrade process, the preselected signal, or upgrade flag, is restored to the predetermined location. The device then proceeds to operate in accord with standard procedures.

Other features and advantages of the present invention will be more clearly understood upon reading of the following description and the accompanying drawings and claims.

### BRIEF DESCRIPTION OF THE DRAWINGS

FIG. 1 is a block diagram of a processing unit illustrating features relevant to present invention according to the prior art.

FIG. 2 is a block diagram of a processing unit according to the present invention.

FIG. 3A illustrates a first portion of the operation of the upgrade procedure, while FIG. 3B illustrates a second portion of the upgrade procedure according to the present invention.

### DESCRIPTION OF THE PREFERRED EMBODIMENT

1. Detailed Description of the Drawings

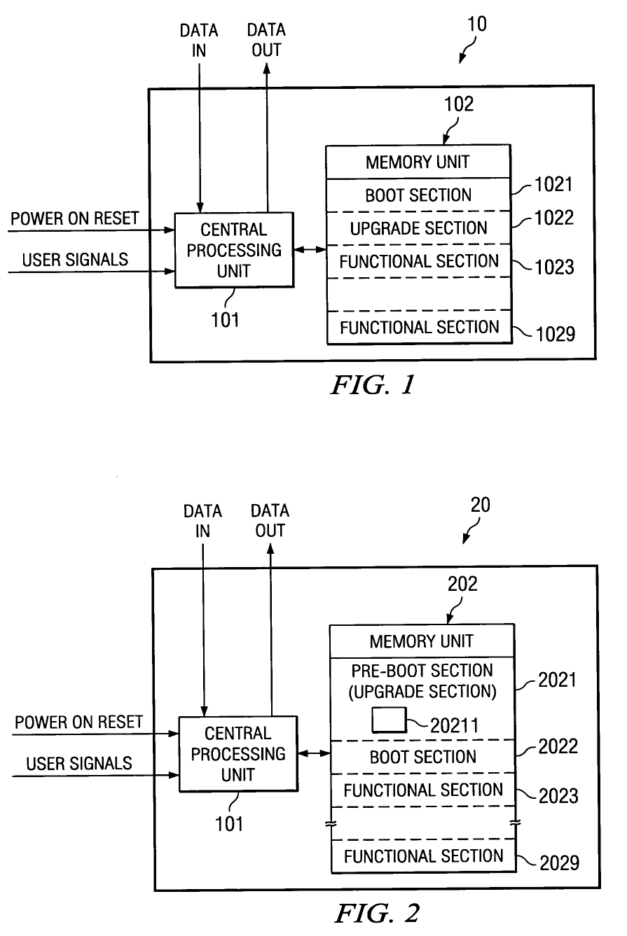

FIG. 1 has been described with respect to the related art.

Referring next to FIG. 2, a block diagram of the micro-processor based device 20 of the present invention is shown. The device 20 includes a central processing unit 101 and a memory unit 202. The central processing unit 101 receives POWER ON/RESET signals, USER signals, and DATA IN signals. The central processing unit 101 provides DATA OUT signals. The central processing unit 101 exchanges signals with memory unit 202. The memory unit 202 includes a pre-boot section 2021, a boot section 2022, and functional sections 2023-2029. The pre-boot section 2021 includes an upgrade section. The program of the pre-boot section 2021 includes a predetermined location 20211. The predetermined location 20211 stores an upgrade flag. When the upgrade flag is present, the most recently attempted upgrade was completed. If the upgrade flag is not present, then the most recent attempt to upgrade device 10 was not completed.

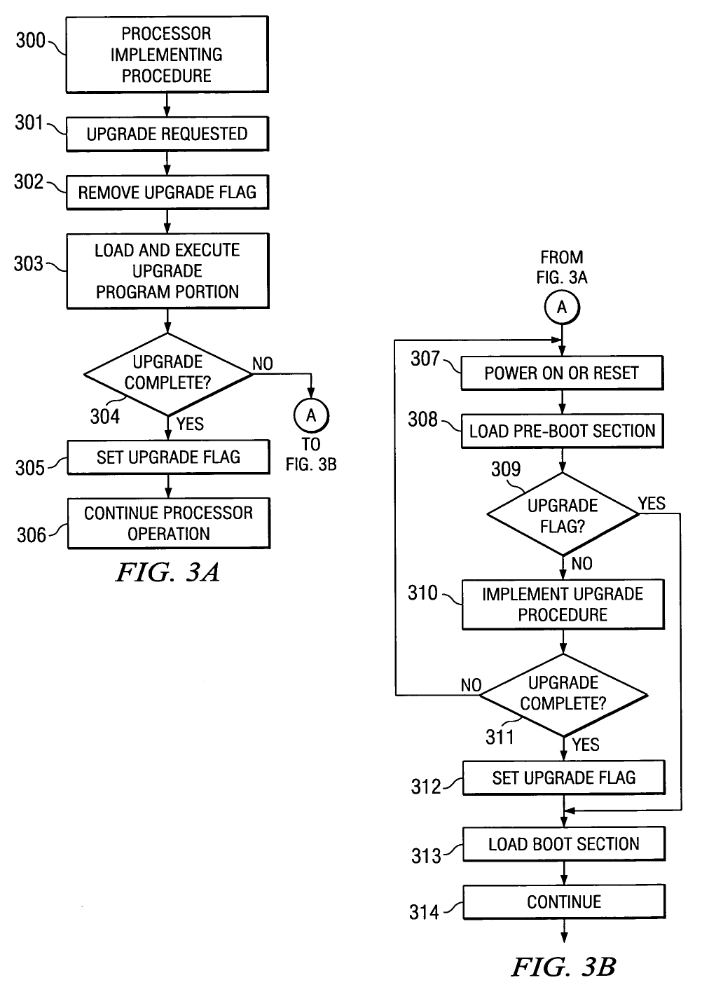

Referring to FIG. 3A, the procedure to upgrade a software/firmware program stored in memory unit 202 during normal operation of the device is illustrated. In step 300, the device 20 is implementing a procedure during normal operation. A request to upgrade the device 10 is received in step 301. In response to the request for an upgrade procedure, the upgrade flag is removed in step 302. In step 303, the upgrade program stored in the pre-boot section 2021 of the memory unit is loaded and executed. A determination is made whether the upgrade s complete in step 304. When the upgrade is complete, the upgrade flag is restored in step 305. The operation of processing unit continues in step 306. When the determination of the completion of the upgrade procedure is false, then the procedure transfers to step 307 in FIG. 3B.

Referring to FIG. 3B, when the upgrade procedure is interrupted for whatever reason, the processing unit 10 is typically stopped or stalled. A POWER ON or RESET signal is applied to device 10. In response to the POWER ON or RESET signal, in step 308, the pre-boot process is begun. In step 309, the location in predetermined location 20211 containing the upgrade flag is tested. When the upgrade flag is not present, then the upgrade program in memory unit section 2021 is transferred to the central processing unit 101 and executed in step 310. A determination is made whether the upgrade program is complete in step 311. When the upgrade program is not complete, then the interrupted processing unit returns to step 307. When the upgrade program is completed in step 311, then the upgrade flag is set in step 312. After the setting of the upgrade flag or when the upgrade flag is present in step 309, then in step 313 the boot load procedure is transferred to the central processing unit and executed. The operation of the processing unit 10 continues in step 4.

2. Operation of the Preferred Embodiment

The present invention provides for the successful implementation of an upgrade procedure. This successful implementation is determined by a flag in a pre-boot program location. When an upgrade procedure is initiated, the upgrade flag is removed. Then, if the upgrade procedure is not successful, the upgrade flag is not restored to the predetermined location. Typically, the failure of an upgrade procedure would be the result of an interruption of the processing activity. After the interruption, the processing unit must be reinitialized, i.e., must be rebooted by executing the boot program. During the early (pre-boot) stages of the initialization procedure, the upgrade flag is examined. When the upgrade flag is present, this presence is an indication that any previous upgrade procedure was successfully completed. The initialization process can therefore continue. When the upgrade flag is absent, then the most recent upgrade attempt was interrupted. The processing device 10, in the absence of the upgrade flag, repeats the upgrade procedure.

In the preferred embodiment, the predetermined location is located in the pre-boot program portion. However, the predetermined location can be physically removed from the pre-boot program section, but still be considered part of the pre-boot section.

As will be clear, any technique for the upgrading of the processing device 10 can be used. Two of the most common techniques are the use of CD devices coupled to the processing device 10 or through an internet interface coupled to the processing device 10. However, other methods for upgrading the processing unit can be used without departing from the present invention.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

What is claimed is:

1. An apparatus comprising:
a central processing unit; and
a non-volatile memory unit exchanging signals with the central processing unit, the memory unit including:
a pre-boot section storing a pre-boot program, the pre-boot program including an upgrade program, the upgrade program causing the central processing unit to upgrade the functional section of the memory unit, the pre-boot section including a predetermined location, pre-boot program determining the presence of a preselected signal in predetermined location upon power on or reset apparatus, the preselected signal indicative of the completion of the most recent upgrade procedure;
a boot section storing a boot program, the boot program initializing the central processing unit; and
a functional section storing functional programs and data, the upgrade program storing a preselected signal in the predetermined location when the upgrade program is activated.

2. The apparatus as recited in claim 1 wherein initiation of the upgrade program causes the preselected signal to be removed from the predetermined location.

3. The apparatus as recited in claim 2 wherein the pre-boot program causes the upgrade program to be activated when the preselected signal is not stored in the predetermined location.

4. The apparatus as recited in claim 3 wherein the preselected signal is restored to the predetermined location when the upgrade program is complete.

5. The apparatus as recited in claim 4 further comprising a CD device coupled to the central processing unit, the CD device providing the data for upgrading at least one functional program.

6. The apparatus as recited in claim 4 further comprising an internet interface coupled to the central processing unit, the internet interface providing the data for upgrading the apparatus at least one functional program.

7. A method for determining when a most recent upgrade of a non-volatile memory in a processing unit has been completed, the method comprising:
removing a preselected signal in a predetermined location in a boot program upon initiation of an upgrade program; and
restoring the preselected signal to the predetermined location upon completion of the upgrade procedure.

8. The method as recited in claim 7 further comprising:
locating the predetermined location in a pre-boot program, the pre-boot program being initiated in response to a power on or a reset signal; and
including the upgrade program in the pre-boot program.

9. The method as recited in claim 8 further comprising providing the data for upgrading the memory from a CD device.

10. The method as recited in claim 8 further comprising providing the data for upgrading the memory from an internet interface.

11. A program for storage in a non-volatile memory of a processing unit, the program comprising:
a pre-boot portion, the pre-boot portion being initiated in response to preestablished signal, the pre-boot portion including an upgrade portion for upgrading a portion of the program; the pre-boot portion including a predetermined location, a preselected signal in the predetermined location being indicative of completion of the most recent upgrade program execution;
a boot portion, the boot portion initializing the processing unit;
at least one functional portion, the function portion being executed in response to user commands.

12. The program recited in claim 11 wherein completion of the execution of the upgrade program causes the preselected signal to be restored in the predetermined location.

13. The program as recited in claim 12 wherein in response to the preselected signal being absent from the predetermined location during the pre-boot procedure, the upgrade program is activated.

14. The program as recited in claim 13 wherein the processing unit includes a CD device, the upgrade data being obtained from the CD device.

15. The program as recited in claim 13 wherein the processing unit includes an internet interface, the upgrade data being obtained from the internet interface.
